(19) United States
(12) Patent Application Publication
(10) Pub. No.: US 2008/0092338 A1
(43) Pub. Date: Apr. 24, 2008

(54) Soft Handle (IV)

(76) Inventor: Michael Chien-Lung Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/583,824

(22) Filed: Oct. 20, 2006

(51) Int. Cl. B25G 1/10

(52) U.S. Cl. 16/430

(57) ABSTRACT

The invention relates to a soft handle (IV), which includes a soft shell, a special shaft, a lower cap, and a top cap. Space between the shell and the shaft can be fulfilled with sticky liquid inside and is sealed by top and lower caps under engaging pieces with outward projections of respective means to form a useful handle. The handle can be easily connected together and obtains a really soft effect for facilitating use when connecting other products.

### FIELD OF THE INVENTION

The present invention relates to a soft handle, which includes a soft shell connecting with an inner shaft. And inner space of the shell is fulfilled with sticky liquid and sealed by an easy locked cap to provide a soft character for handling.

### BACKGROUND OF THE INVENTION

There are many products having a handle for facilitating users to hold, such as umbrellas, hair driers, combs, and so on. The traditional handle always has a hard rigid structure. After using a period of time, people feel uncomfortable usually. Although the known handle sometimes has a rubber cover, it is still not soft enough. People will get uncomfortable after a long time use.

### SUMMARY OF THE INVENTION

The present invention is to provide a soft handle, which includes a soft shell connecting with a specific inner shaft and being fulfilled with sticky liquid inside to form a really soft contact for comfortable use. Now, accompanying with the following drawings, the character of the present invention will be described here and after.

### BRIEF DESCRIPTION OF THE DRAWINGS

FIG. 1 is a perspective view showing a soft handle according to the present invention.

FIG. 2 is an exploded perspective view of FIG. 1.

FIG. 3 is an assembled cross-sectional view of FIG. 2.

FIG. 4 is a plan view showing an embodiment of filling liquid into the handle.

FIG. 5 is a plan view showing the soft handle applied on an umbrella according to the present invention.

### DETAILED DESCRIPTION OF THE PREFERRED EMBODIMENT

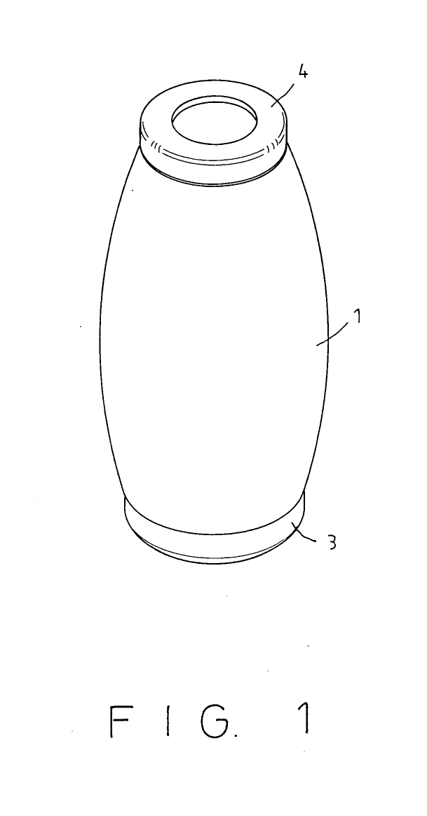

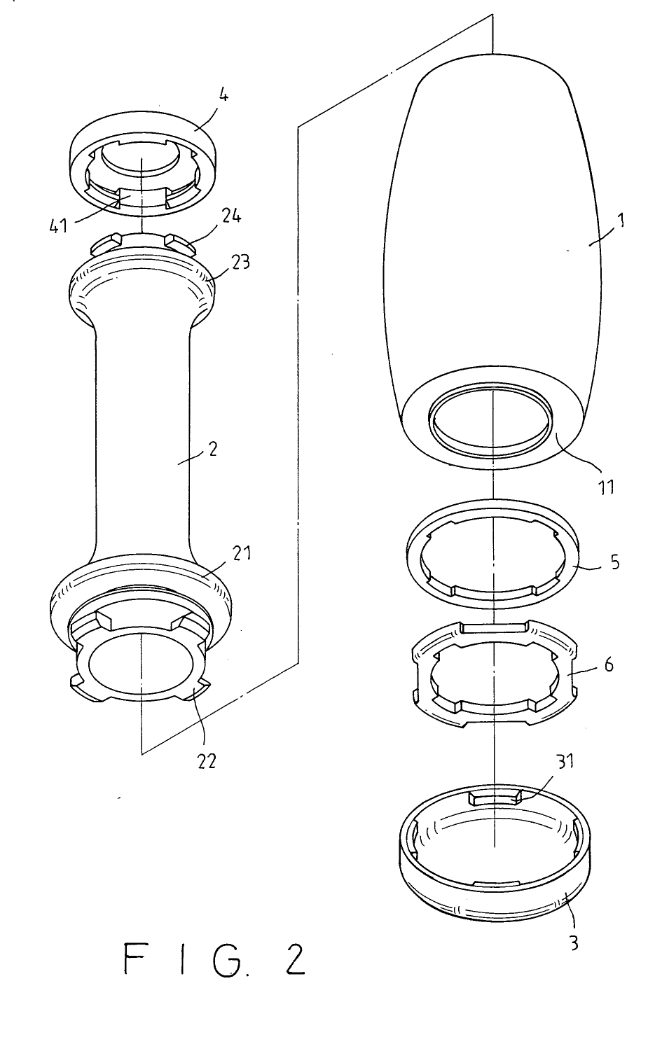

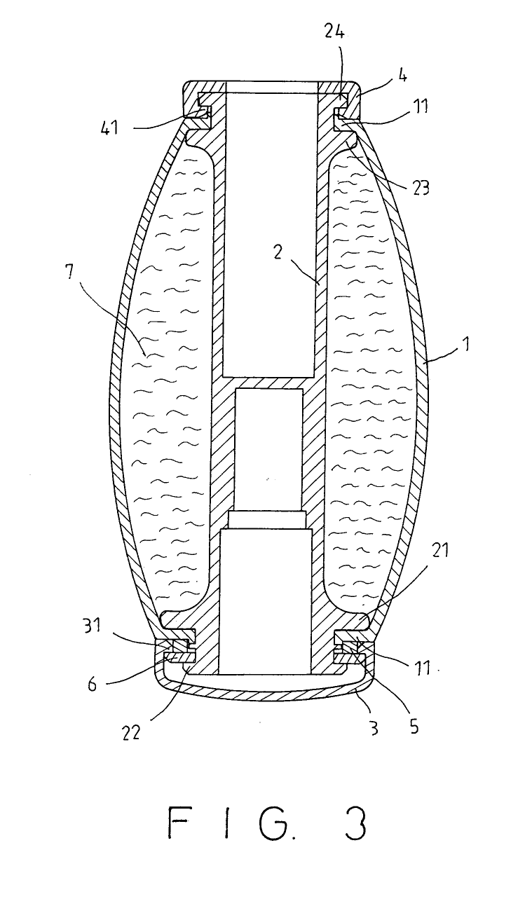

Please refer to FIG. 1 to 3; the present invention relates to a soft handle, which includes a soft shell (1) with an upper and a bottom inward flange (11), which is made of soft material. A shaft (2) placed in the shell (1) has a lower convex edge (21) to contact the inner surface of the bottom inward flange (11) and has several side projections (22) outwards for engaging with connecting pieces (31) in a lower cap (3) to obtain an easy connection. A sealing (5) and an engaging ring (6) are provided in the lower cap (3) between the bottom flange (11) of the shell (1) and the shaft (2) to form a secure connection. The shaft (2) also has an upper convex edge (23) to contact the inner surface of the top inward flange (11) of the shell (1) and has several outward projections (24) to engage with a top cap (4) very easily.

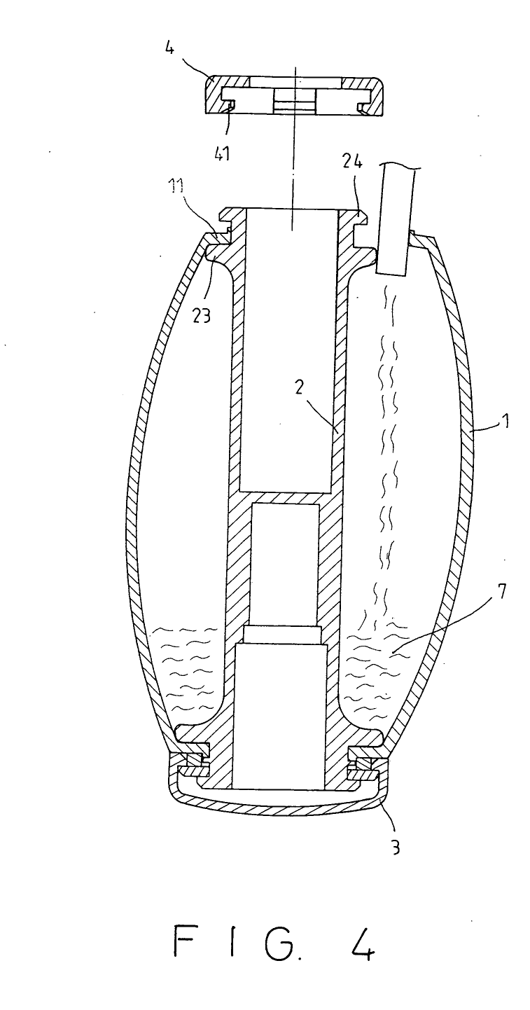

Referring to FIG. 4, it shows an example of filling liquid (7) into the handle, wherein the top portion of the shell (1) can be pulled to expose an opening. Liquid (7) can be then fulfilled in the space between the shell (1) and the shaft (2). Last, the upper cap (4) engages with the top end of the shaft (2) in ease and the soft handle is completed according to the present invention.

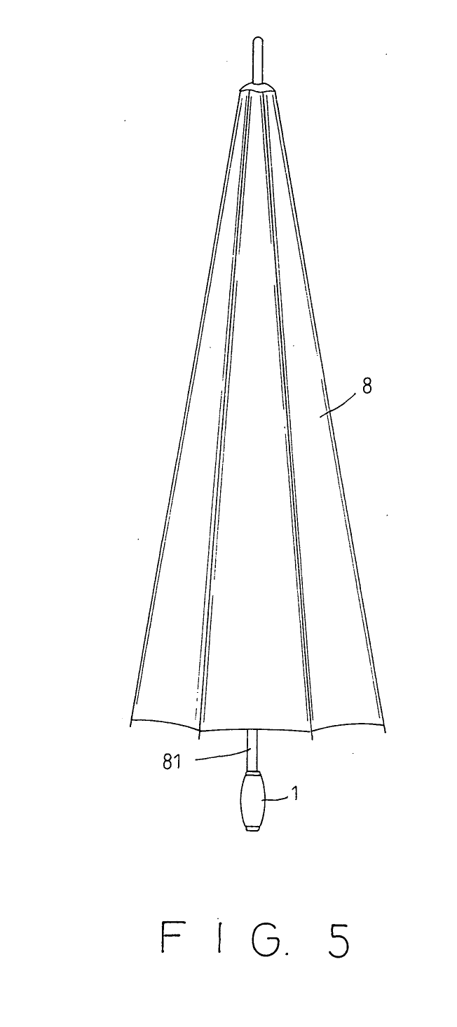

In use, such as shown in FIG. 5, the present invention can use a central hole on the shaft (2) to connect with other products directly, such as a shaft (81) of an umbrella (8). Since the shell (1) with inner sticky liquid (7) is very soft, the umbrella with the handle of the present invention can be used comfortable even a very long time use.

In above description, they are only embodiments to illustrate our embodiment and are not to limit the scope of this application. Any modified embodiments with similar merits are also claimed according to the present invention.

I claim:

1. A soft handle (IV) including a soft shell with an upper and a bottom inward flange, which is made of soft material,
a shaft placed in the shell having a lower convex edge to contact with the inner surface of the bottom inward flange and having several side projections outwards for engaging with connecting pieces in a lower cap accompanying with a sealing and an engaging ring to obtain an easy connection among the lower cap, the bottom flange of the shell, and the shaft securely,
the shaft also having an upper convex edge to contact the inner surface of the top inward flange of the shell and has several outward projections to engage with a top cap, and
space between the shell and the shaft being fulfilled with sticky liquid and when liquid is fulfilled, the upper cap engaging with the top cap then for completing the soft handle in ease.
